(19) United States
(12) Patent Application Publication
(10) Pub. No.: US 2022/0414346 A1
(43) Pub. Date: Dec. 29, 2022

(54) STICKERING METHOD AND SYSTEM FOR LINKING CONTEXTUAL TEXT ELEMENTS TO ACTIONS

(71) Applicant: AI ROBOTICS LIMITED, Hong Kong (CN)

(72) Inventors: Chien Wei Chia, Singapore (SG); Bhagwan Jethanand Daswani, Hong Kong (HK)

(73) Assignee: Artificial Intelligence Robotics Pte. Ltd., Singapore (SG)

(21) Appl. No.: 17/630,198

(22) PCT Filed: Jul. 29, 2019
(86) PCT No.: PCT/SG2019/050369

§ 371 Date: Jan. 26, 2022

(51) Int. Cl. G06F 40/40; G06F 16/28

(52) U.S. Cl. CPC G06F 40/40; G06F 16/288

(57) ABSTRACT

A stickering system and method of managing electronic texts and related actions for real-time reinforcement learning based on machine learning, including: determining a contextual element in at least a part of an electronic text; linking a set of stickers with the contextual element and an action to define a relationship; and configuring a knowledge structure, in which the knowledge structure is re-configurable by storing the relationship in a stickers database.

### TECHNICAL FIELD

This application relates to a method and system of managing electronic text elements and related actions for real-time reinforcement learning based on machine learning using Natural Language Processing (NLP).

### BACKGROUND

Many interactions between people involve the exchange of electronic texts, whether the interactions are related to work, social, personal or other matters. Electronic text may be exchanged using communication tools such as web browsers, messaging apps, social networking platforms, email clients, and/or other software and mobile apps. These also include broadcast of news on websites, blogs, opinions, etc. in textual forms or texts emanating from speech in videos using Speech-to-Text technologies and textual material in Portable Document Format (PDF).

Interactions with these texts could be short term or sustained over several months. There is also a trend that the volume of such electronic text exchange is on the increase. For example, in present times, it is not unusual for people to spend more and more hours each day managing emails and chat applications at work or home. Nor is it unusual for people to read and interpret increasingly more electronic text so that they can be kept abreast of relevant evolving issues and technologies, especially given the that the Fourth Industrial Revolution is unfolding. Outside of work, it is also common for people to deal with a large volume of texts, and send and receive a large volume of emails, for example, in social media and from digital marketing vendors respectively.

In reality, all such exchanges are highly complex and contextual in nature dealing with a wide variety of subject matters. Each exchange can have many meanings depending on the prevailing perspectives. As a result, interpreting the text, taking a stand and deciding the consequent actions, whether it is a simple act of replying “Yes” or “No” or a more complex action of triggering a chain of work sequences for instance, is highly contextual and continue to be a very manual process.

As such, there is therefore a need for more efficient ways of managing electronic texts, whether they are chat messages, email messages, broadcasts and opinions of latest news on websites, blogs, PDF chapters from the latest books on technologies in textual forms or texts emanating from speech in videos using Speech-to-Text technologies.

### SUMMARY

The present application provides an embodiment of a method implementable by a computing device having a computer-readable medium carrying computer-executable code, the method involving determining a contextual element in at least a part of an electronic text; linking a set of stickers with the contextual element and an action to define a relationship; and configuring a knowledge structure, in which the knowledge structure is configurable by storing the relationship in a stickers database coupled to the computing device.

The knowledge structure may be re-configurable by storing an updated relationship in the stickers database. The embodiment may include providing a user interface configured to enable a user to re-configure the knowledge structure by: defining the updated relationship; and storing the updated relationship in the stickers database. The computing device may be further configured to suggest a candidate relationship, in which the candidate relationship is drawn from a model trained with a plurality of contextual elements associated with a plurality of relationships stored in the stickers database. The model includes a natural language processing (NLP) model. The computing device may be further configured to define the updated relationship, and the updated relationship includes a partly or wholly reconfigured plurality of relationships stored in the stickers database. The updated relationship may be drawn from a natural language processing (NLP) model trainable by a plurality of relationships stored in the stickers database. The NLP model may be further trainable by the updated relationship. The embodiment may include determining the set of stickers so that each sticker of the set of stickers is associated with a different sticker level, wherein the set of stickers includes one or more stickers, each of the one or more stickers corresponding to an aspect of a context related to the electronic text. The set of stickers may further include a plurality of stickers configured in a hierarchy of sticker levels. The embodiment may include storing the set of stickers as a persistent property of the linked contextual element in the stickers database. The embodiment may include: initiating the action to answer a query, the query being at least a part of the contextual element.

There is provided an embodiment of a method implementable by a computing device having a computer-readable medium carrying computer-executable code, the method involving: using at least a part of a first electronic text, determining a contextual element; determining a set of stickers corresponding to a perspective of a context of the first electronic text; linking the contextual element with the set of stickers and an action to define a relationship; and storing the relationship in a stickers database representing a knowledge structure, in which the storing of the relationship modifies the knowledge structure.

The method may further include: using input from a machine learning module to determine at least one of the following: the contextual element, the set of stickers, and the action, wherein the machine learning module is coupled with the stickers database such that the input is determined by the knowledge structure. The method may further include: using input from a machine learning module to determine the relationship, wherein the machine learning module is coupled with the stickers database such that the input is determined by the knowledge structure. The method may further include: using a further input from a user interface to modify the input from the machine learning module, wherein the user interface is coupled with the stickers database such that the knowledge structure can be further modified by the further input from the user interface. The method may further include: using input from a user interface to determine at least one of the following: the contextual element, the set of stickers, and the action, wherein the user interface is coupled with the stickers database such that the knowledge structure can be modified by the input. The relationship may further include updating the relationship by using input from a machine learning module to change at least one of the contextual element and the set of stickers. The set of stickers may include at least one sticker, each of the at least one sticker being associated with a respective sticker level in a hierarchy of sticker levels. The method may further include: determining the action, in which the action is determined in part by the set of stickers; using a result of the action to form a second electronic text; using at least a part of the second electronic text, determining a second contextual element; determining a second set of stickers; linking the second contextual element with the second set of stickers to define an updated relationship related to the action; and modifying the knowledge structure by storing the updated relationship. The method may further include parsing the contextual element using natural language processing. The embodiment may include the first electronic text being an electronic message; and in which the contextual element is determined from: at least a part of a message header of the electronic message, at least a part of a message body of the electronic message, at least a part of the message header and at least a part of the message body of the electronic message, or the electronic message as a whole.

There is provided an embodiment of a system operable by a user to manage electronic texts, the system including: a user interface 1580; a stickers database configured as a knowledge structure, the stickers database being coupled to the user interface so that the knowledge structure; and a computing device coupled to the stickers database and the user interface, the computing device being configured to: use at least a part of a first electronic text to determine a contextual element; determine a set of stickers corresponding to the user's perspective of a context of the first electronic text; the set of stickers including at least one sticker, each of the at least one sticker being associated with a respective sticker level in a hierarchy of sticker levels, the hierarchy of sticker levels being configurable by the user through the user interface; link the contextual element with the set of stickers to define a relationship related to an action; and store the relationship in the stickers database, wherein the knowledge structure is modified by the relationship stored in the stickers database, and in which the knowledge structure is configurable by the user providing input through the user interface.

The system may be configured in which the knowledge structure is configurable by the user providing input through the user interface to determine the contextual element. The system may be configured in which the knowledge structure is configurable by the user providing input through the user interface to determine the set of stickers. The system may be configured in which the knowledge structure is configurable by the user providing input through the user interface to link the contextual element with the set of stickers. The system may be configured in which the knowledge structure is configurable by the user providing input through the user interface to determine the action. There is provided an embodiment of a method implementable by a computing device having a computer-readable medium carrying computer-executable code, the method involving: using at least a part of a first electronic text, determining a contextual element; determining a set of stickers corresponding to a perspective of a context of the first electronic text; linking the contextual element with the set of stickers to define a relationship related to an action; and storing the relationship in a stickers database representing a knowledge structure, in which the storing of the relationship modifies the knowledge structure.

### BRIEF DESCRIPTION OF DRAWINGS

FIG. 1 is a schematic drawing showing one embodiment of a stickering system.

FIG. 2 is a schematic flowchart showing one embodiment of a stickering method.

FIG. 3 is a schematic drawing showing a hierarchical order of stickers, according to one embodiment.

FIG. 4 is a schematic representation of a knowledge structure, according to one embodiment.

FIG. 5 is a schematic representation of a training/deployment architecture, according to one embodiment.

FIG. 6 is a schematic representation of a user interface, according to one embodiment.

FIG. 7 is a schematic representation of an electronic message.

FIG. 8 is a schematic representation of a stickering tool, according to one embodiment.

FIG. 9 is a schematic representation of a stickering tool, according to another embodiment.

FIG. 10 is a schematic representation of a stickering tool, according to another embodiment.

FIG. 11 is a schematic representation of a stickering tool, according to another embodiment.

FIG. 12 is a schematic flowchart of a stickering method, according to one embodiment.

FIG. 13 is a schematic flowchart of a stickering method, according to another embodiment.

FIG. 14 is a schematic flowchart of a stickering method, according to another embodiment.

FIG. 15 is a schematic diagram of an embodiment of the stickering method and system.

FIG. 16 is a schematic diagram of another embodiment of the stickering method and system.

FIG. 17 is a schematic diagram illustrating another embodiment of the stickering method and system.

### DETAILED DESCRIPTION

It will be readily understood that the components of the embodiments, as generally described and illustrated in the figures herein, may be arranged and designed in a wide variety of different configurations in addition to the described example embodiments. Thus, the following description of the example embodiments, as represented in conjunction with the figures, is not intended to limit the scope of the embodiments, as claimed, but is merely representative of example embodiments.

Reference throughout this disclosure to “one embodiment”, “another embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments may be practiced without one or more of the specific details, or with other methods, components, materials, etc. In other instances, some or all known structures, materials, or operations may not be shown or described in detail for the sake of clarity.

It can be understood that embodiments of the present disclosure can also be applied to various different work, personal or social situations. One example of a strategic work application includes a situation where a chairman of the board of directors reads an important development of a competing technology online and triggers investigative actions with an embodiment of the present disclosure. As a non-work example where embodiments of the present disclosure can be applied, a person interested in the concept of “team cohesion” comes across a new research article on methods to develop team cohesion, and triggers an automated comparative analysis action with previous known concepts from text sources that are searchable online or had already been archived. The following description makes references to a work environment merely as examples, and it should be understood that this does not limit the embodiments of the present disclosure to only work-related applications.

For the purpose of the present disclosure, transmission of an electronic text includes communication between a user and at least one other person in which the communication involves electronic text, such as but not limited to emails, to exchange information, ask questions, seek clarifications, provide information, answer questions, provide updates, etc. Transmission of an electronic text can also include, but is not limited to, publishing, uploading, downloading, forwarding (for example, by hyperlink and/or attachment), and/or such ways of providing the electronic text. There may be a specifically identified recipient or recipients of a transmission, such as in the case of an email or chat. There may not be a specifically identified recipient or recipients of the transmission, such as when the electronic text is part of (or the whole of) a website. For the purpose of this disclosure, a “user” refers to a person who is a creator, sender, transmitter, reader, recipient and/or actor in respect to one or more than one electronic text used in a communication. The user does not need to be skilled in software/firmware programming in order to use the method and system disclosed in this document.

In the present disclosure, the “context” of an electronic text refers to background events (situations and things that happen) and interactions (communications) related to the electronic message towards some goal(s) or end(s); such as completion of a batch of products or samples in a manufacturing environment. While it can be appreciated that context aids understanding of an electronic text, it is also reality that the context of any electronic text can be highly complex and can include unspoken implications on top of the various perspectives that can be adopted by different users.

In one example, a customer had earlier engaged a manufacturer to manufacture various types of products. Over a period of several months, there were several turns of electronic messages exchanged. At some point in time, it was found that there was a quality issue with one of the samples delivered by the manufacturer to the customer. Thus, at this time when the customer sends an electronic message to the contract manufacturer asking “when is delivery?” it is important to go beyond looking at the literal meaning of the text of the electronic message. A recipient looking at the literal meaning of the text of the electronic message can at best understand that the customer wants to know when is a delivery date. Without knowledge of the context, he may wrongly determine that it is a normal delivery situation. He would have to search through weeks or even months of electronic messages to find all the related electronic messages, and piece together various bits of information from many electronic messages, before he can make an appropriate response to the customer. If the recipient does not have (or cannot find) all of the related electronic messages exchanged with the customer, he may fail to consider important information when dealing with the irate customer. It is also important to make a quick response to the customer, but it takes time to dig through all the previous months of electronic messages. Without such important insight into the context of the electronic message, the supplier may fail to take steps to improve customer relationship and also fail to look into possible causes for the quality issue.

It can therefore be appreciated that, “context” of an electronic text as used in the present disclosure can include more than the literal meaning of the electronic text. While “context” as used in the present disclosure can include, but is not limited to, a user's information (such as a user's past purchase history, a user's geographical location, a user's social media profile, etc.) and/or attributes of an electronic message (such as a time stamp of the electronic message, a recipient's email address or phone number, etc.), clearly, this example illustrates that just having the user's information and/or the attributes of the electronic message may be insufficient to gain a desired insight into the related background events and/or the related background interactions.

Embodiments of the present disclosure include a method and system that is configured to recognize that a context of an electronic text can change. The context of an electronic text may change over time or as conditions change. While an electronic text may be described as “static” once it has been composed and/or transmitted, the context related to the electronic text may be described as “dynamic” as it may change. Embodiments of the present disclosure include a method and system that is configured to recognize that a context of an electronic text may be perceived in more than one way. Different perspectives may arise because the context is perceived by different users, or because the context is perceived by one user who changes in the way he/she perceives the context. With respect to an electronic text, there may be a plurality of perceptions of a dynamic context.

For the sake of convenience and not intended to be limiting, one or more related or connected background events and/or interactions may be referred to as a “project”. This is regardless of whether the background events and/or interactions are work related. Each project may be referred to by some identifier such as a project name or an identification. For example, a work-related project to design a new product may be assigned a project name in the form of a design code for reference by the parties involved in the project. In another example, a non-work-related project to plan a wedding event may be assigned a project name such as “Jenny's wedding” for reference by the parties involved in the project. Embodiments of the present disclosure include a method and system configured to recognize that a project may be perceived differently by different users, one or more of whom may be actor(s) in one or more of the related background events and/or interactions. For the purpose of the present disclosure, a project may be described as being made up of a plurality of phases. For example, a first phase may include first background events, and a second phase may include second background events, and all of the first background events occur earlier in time compared to all of the second background events. In other examples, the various phases of a project may be defined by one or more characteristics of the related background events and/or interactions. For example, the background events and/or interactions related to “human resource” may be classified into one phase, and the background events related to “equipment” may be classified into another phase. The phase “human resource” and the phase “equipment” need not be in a chronological sequence relative to with one another. In other words, an aspect can be a perspective and different meanings can be derived when texts are read from various perspectives.

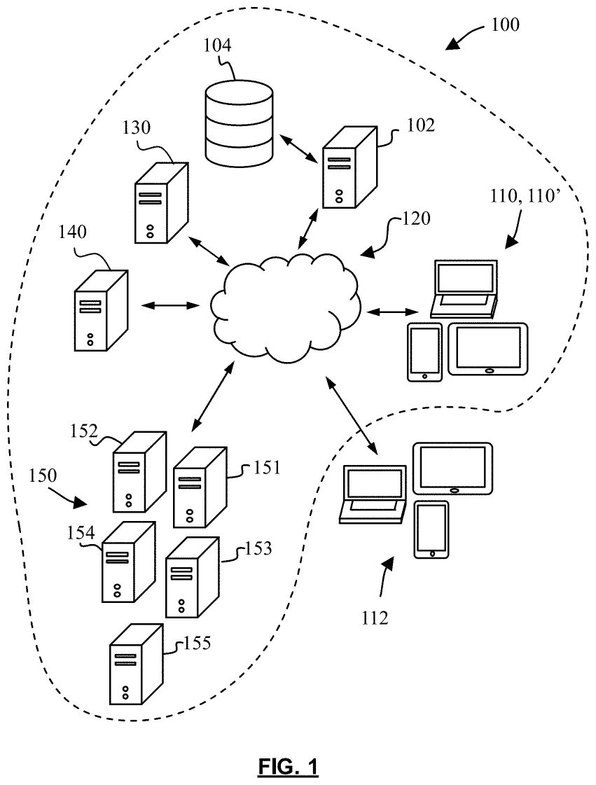

FIG. 1 shows an embodiment of a stickering system 100 configured to perform a stickering method, in which the stickering system includes a computing device 102 coupled with a stickers database 104. Computing devices can include laptops, desktop computers, tablets, mobile phones, smart watches, and/or other electronic devices. The stickering system and the stickers database may be embodied in the form of computer-executable code stored in computer-readable medium coupled to the computing device 102. Components of the stickering system 100 may be coupled with one another through local and/or remote coupling, as part of a network or as part of a plurality of networks 120, or as part of a computing device. The computing device may be coupled configured to provide a user interface 110. Through the user interface 110, a user can perform a stickering method in accordance with one embodiment of the present disclosure. Using the user interface 110, a first user can also transmit and/or receive electronic text with a second user, in which the second user uses a second user interface 110′ configured in accordance with one embodiment of the present disclosure. Using the first user interface 110, the first user may transmit and/or receive electronic text with a third user, in which the third user uses a third user interface 112 that is not configured to enable the third user to perform a stickering method.

In one embodiment, the stickering system is configured to be operable with an electronic message client, such as an email client. The email client refers to a mail user agent and/or a mobile application (mobile app), that can be run on one or more computing devices, such as the computing device 102 and/or the user interface 110. The stickering system can provide for two or more electronic message clients of the stickering system to electronically communicate with one another. The stickering system can also provide for the electronic message client of the stickering system to electronically communicate with an external electronic message client. In this document, “external electronic message client” refers to a conventional electronic message client, for example, an email client that does not offer a user the various useful features and functional advantages made possible by embodiments of the present disclosure. Thus, it can be understood that an electronic message client of the present embodiment and a conventional electronic message client can co-exist and exchange messages or electronic mail within a physical organization, within a virtual organization, and/or across different physical and/or virtual organizations. The system includes a computer-readable medium having computer-executable code to perform a method in accordance with any embodiment described in this document.

In another embodiment, the stickering system includes a machine learning module 130, such as one configured with Natural Language Processing (NLP) Artificial Intelligence (A.I.) engine. The machine learning module 130 may be coupled with the rest of the stickering system 100 through local and/or remote coupling 120, as part of the network or as part of the plurality of networks, or as computer executable code residing in a memory of the computing device 102. In one embodiment, the machine learning module is configured to implement reinforcement learning. Reinforcement learning may include (but is not limited to) one or more of the following: supervised learning, unsupervised learning, sequence to sequence learning and classification learning.

The machine learning module may be configured to include one or more sub-modules. The machine learning module may include a sub-module configured to implement one or more artificial neural network models. Examples of the artificial neural network models include, but are not limited to: back-propagation method, Hopfield network method, self-organizing map method, and a learning vector quantization method, etc. The machine learning module may include a sub-module configured to implement one or more deep learning algorithms. Examples of the deep learning algorithms include, but are not limited to: deep belief network method, convolutional neural network method, recurrent neural network method, stacked auto-encoder method, etc. The machine learning module may include a sub-module configured to implement one or more dimensionality reduction methods. Examples of the dimensionality reduction methods include, but are not limited to: principal component analysis, partial least squares regression, Sammon mapping, multidimensional scaling, projection pursuit, etc. The machine learning module may include a sub-module configured to implement one or more feature-extraction methods. The machine learning module may include a sub-module configured to implement one or more embedding-generation methods. Examples of the feature-extraction methods and/or embedding-generation methods include, but are not limited to: Continuous Bag of Words (CBOW), Skip-gram, etc. The machine learning module may include a sub-module configured to implement one or more ensemble methods. Examples of the ensemble methods include, but are not limited to: boosting, stacked generalization, gradient boosting machine method, random forest method, etc. The machine learning module may include a sub-module configured to implement one or more instance-based methods. Examples of the instance-based methods include, but are not limited to: k-nearest neighbor, self-organizing map, etc. The machine learning module may include a sub-module configured to implement one or more Bayesian methods. Examples of the Bayesian methods include, but are not limited to: naïve Bayes, Bayesian belief network, etc. The machine learning module may include a sub-module configured to implement one or more clustering methods. Examples of the clustering methods include, but are not limited to: k-means clustering, expectation maximization, etc. The machine learning module may be configured to include one or more sub-modules, in which the sub-modules may be configured to implement one or more of the following in combination: artificial neural network model, deep learning algorithm, dimensionality reduction method, feature-extraction method, embedding-generation method, ensemble method, instance-based method, Bayesian method, clustering, and other suitable methods.

In another embodiment, the stickering system is further coupled with an analytics module 140. The analytics module 140 may be coupled with the rest of the stickering system 100 through local and/or remote coupling 120, as part of the network or as part of the plurality of networks, or as computer executable code residing in a memory of the computing device 102.

In another embodiment, the stickering system 100 may be coupled to one or more action modules 150. Examples of the action modules include but are not limited to: an electronic text transmission module 151, one or more office tools 152, a ticketing system 153, a robotics system 154, and a robotic process automation (RPA) system 155. The stickering system may be configured to be operable with at least one implementation module selected from the following implementation modules: an electronic text transmission module, an office tool, a ticketing system, a robotics system, and a robotic process automation (RPA) system. The office tool may include one or more software-enabled tools, such as word processing tools, spreadsheet tools, presentation tools, financial management tools, report generation tools, archiving tools, engineering drawing tools, etc. The robotics system may include, for instance, physical manufacturing robots that form part of a manufacturing production line. The RPA system may include software robots configured to execute automated routine processes. The rest of the stickering system 100 may be coupled with each or several of the action modules 150 through local and/or remote coupling, as part of the network or as part of the plurality of networks, or each or several of the implementation modules may be in the form of computer executable code residing in a memory of the computing device 102.

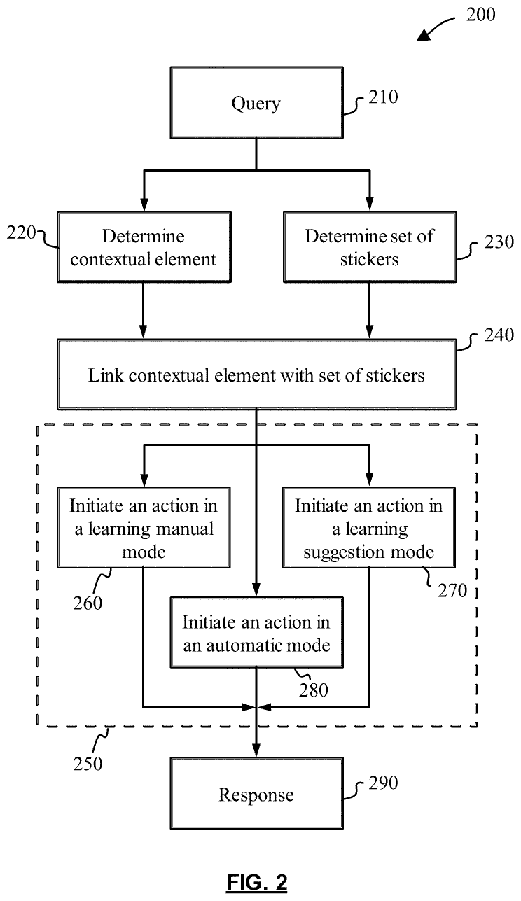

As illustrated schematically in FIG. 2, a method 200 according to one embodiment of the present disclosure includes, responsive to receiving a query 210, defining a contextual element in an electronic text associated with the query 220, and defining a set of stickers 230. The method further includes linking the contextual element to the set of stickers 240 to define a relationship. The method further includes initiating an action 250. This may include initiating an action in a learning mode 260, initiating an action in a suggestion mode 270, and/or initiating an action in an automatic mode 280. The method may further include making a response to the query 290 based on an outcome of the action initiated.

The query may take the form of an electronic message addressed to a user using the user interface 110. The query may take the form of a word, a string of characters, or a sentence, etc., in an electronic message. A non-limiting example of an electronic message is an email. The stickering system is configured to enable the user to define one or more contextual elements taken from the electronic text 220. For the purpose of this disclosure, examples of the electronic text include, but are not limited to one or more of the following that are associated with the electronic message: text, graphics, audio, videos, links, linked content, linked addresses, attachments, and/or content of the attachments. Defining the contextual element may take the form of selecting the whole or a part of the electronic text. The stickering system is configured to enable the user to define one or more sets of stickers in relation to the electronic text 230. Steps of defining a contextual element and defining a set of stickers need not be in any specific chronological order. Defining a set of stickers includes defining one or more stickers. A set of stickers may include only one sticker. A set of stickers may include a plurality of stickers. In a set of stickers, each sticker is associated with a sticker level. The user may define a plurality of sticker levels according to a hierarchy or a cascading configuration. In a set of stickers with a plurality of stickers, each sticker is associated with a different sticker level. A sticker associated with a lower sticker level is related to a sticker at a next higher sticker level.

The stickering system is configured to provide a relationship between a contextual element, a set of stickers 240, and an action 250. The stickering system may be configured to enable the user to link the contextual element with the set of stickers 240, and to initiate an action responsive to the query 250. The stickering system may be configured to enable the user to link the contextual element with the set of stickers 240, and to record an action related to the query 250. In the present disclosure, the above method of linking a contextual element to a set of stickers to an action is referred to as “stickering”. This is clearly distinguishable from a single act of just labeling, tagging or hash-tagging. As will be understood by one skilled in the art, hash-tagging is typing a pound sign (“#”) before a string of characters. In contrast, according to embodiments of the present disclosure, the stickering method involves a relationship between a set of stickers and a contextual element that includes linking between the set of stickers and an action. There is provided a stickering system to define a relationship between a contextual element, a set of stickers, and an action. The stickering system is configured to configure a knowledge structure using stickering, for example, by storing the relationships. The knowledge structure may be re-configurable manually by the user. “Re-configuring”, “updating”, “changing”, “modifying”, etc. are used interchangeably in this document. The knowledge structure may be re-configurable with the aid of suggestions from the stickering system. The knowledge structure may be re-configurable automatically by the stickering system. Configuring or re-configuring the knowledge structure can include storing the contextual element, the set of stickers, and the action, in a non-volatile memory, for example in the stickers database. This can take the form of storing updated or modified relationships in the stickers database. This can take the form of storing the sticker as a persistent property of the contextual element, for example. Maintaining the relationship can also include changing the relationship by changing one or more of the following: the contextual element, the set of stickers, one or more stickers of the set of stickers, and the action. In other words, the stickering system is configured so that it can evolve or be responsive to a dynamic context.

The stickering system is configured to trigger an action in response to a dynamic context of a query 250. The stickering system may be configured to enable a response to a query 290, in which the query has a dynamic context, and in which the response is based on an outcome of an action, and in which the action is initiated by a set of stickers linked to the query. The system may be configured to enable a response to a query received by a user 290, in which the query is related to a context, and in which the response is based on an outcome of an action, the action being determined by a set of stickers, the stickering system being configured to linked to selected by the user responsive to linking a contextual element of the query with a set of stickers, in which the set of stickers corresponds to the user's perspective of the context.

In the example given above, when the customer sends a query to the manufacturer 210, a part or the whole of the electronic message “when is delivery” can be selected to be a contextual element 220. The contextual element is linked with a set of stickers 240. The set of stickers includes at least one sticker, for example, “quality” selected from a predetermined library of stickers 230. The set of stickers describes an aspect of the context of the electronic message, for example, there is a quality issue with the product. An example of an action includes seeking and/or obtaining information on the delivery date of the replacement products 250. The action thus enables the user to respond to the electronic message 290. Another example of an action responsive to the context may include checking with the factory on whether the quality issue has been resolved and responding to the customer to update on the status of resolving the quality issue. One embodiment of the present system includes a non-transitory computer-readable storage medium having computer-executable code for enabling a method, in which the method includes defining a contextual element based on an electronic message, and linking the contextual element to a set of stickers, in which the set of stickers follow a classification scheme, in which the classification scheme includes at least one classification level, each of the at least one classification level corresponding to one aspect of a context of the electronic message. The method further includes using the stickers to trigger an action, the action being intended to enable a response to the electronic message. In such an embodiment, the user provides the initial knowledge to link contextual elements to actions with stickers. This is known as the learning manual mode 260. As the system learns, the system is operable in a learning suggestion mode 270 in which the system can now take the necessary contextual actions given a contextual element and a predicted sticker. In the learning suggestion mode, the stickering system may be configured to suggest possible stickers or candidate stickers for linking with the contextual element. In the learning suggestion mode, the stickering system may be configured to provide the user with a user interface to edit, replace, or otherwise change the candidate stickers suggested by the stickering system. In other words, in the learning suggestion mode, the user is able to re-sticker the suggestions from the stickering system when necessary, for example, to correct the stickering system. In an automatic mode, the stickering system is configured to initiate an action responsive to the contextual element and the set of stickers, without the user's input at this time. The stickering system is configured to trigger the action given a contextual element and a candidate sticker, in which the candidate sticker is a predicted sticker provided by the stickering system automatically, based on the inputs and learnings from the learning manual mode and/or the learning suggestion mode.

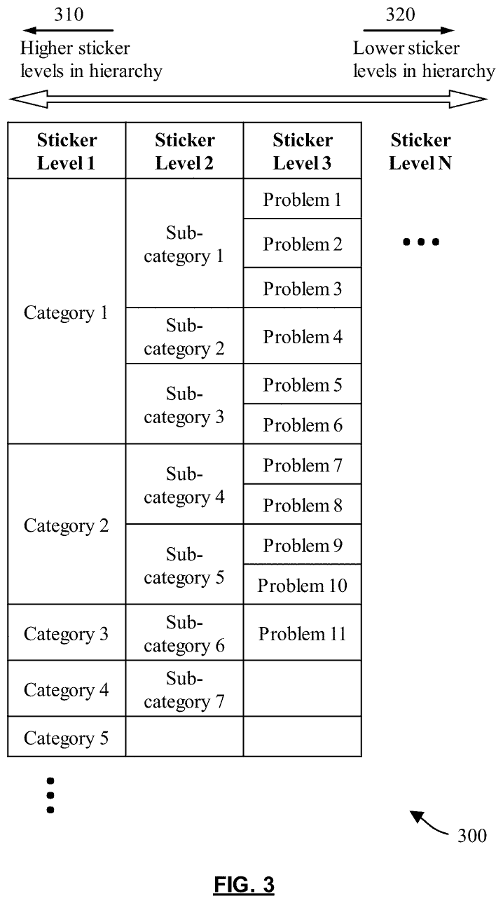

In one embodiment, the stickers follow a sticker hierarchy or a sticker classification scheme in which the classification scheme can be defined by a user, using a user interface provided by the system. The user need not know how to code or write computer programs in order to define the classification scheme. In the example shown schematically in FIG. 3, the classification scheme 300 includes a broadest or highest sticker level “sticker level 1”, a next lower sticker level “sticker level 2”, and a next lower sticker level “sticker level 3”. In other words, the stickers are ordered according to a hierarchy with higher sticker levels 310 and lower sticker levels 320. With the next lower sticker level, the classification scheme is able to narrow down and focus more specifically on an aspect of the context of the electronic message. The user interface may be configured so that the user can select one sticker from a plurality of stickers presented for selection for one sticker level. In one example, the user may select the sticker “sample” from a plurality of stickers (“sample”, “production”, “delivery”) presented at the sticker level 1. The user interface may be configured so that the user can create one or more stickers for each classification level. For instance, supposing the system did not include a sticker “quality” at the sticker level 3, the user can create such a sticker “quality” at the time of linking with the contextual element. The various sticker levels can also be defined for different ways of describing aspects of the context. In this example, the sticker level 1 is used for “categories”, sticker level 2 is used for “sub-categories” and sticker level 3 is used for “problem”. In this example, a set of stickers may include three stickers, each being one at a different sticker level, such as: “category 1”-“sub-category 3”-problem 5”.

The stickers are organized in a cascading manner. This means that selecting a sticker of a higher layer of the hierarchy will determine the stickers available for use at the lower layer of the hierarchy. The set of stickers may be linked to the contextual element in the form of a persistent property of the contextual element. The contextual element and the linked set of stickers can be stored in a database. By accumulating contextual elements and their associated layers of stickers, the system can learn that a presence of a certain contextual element in an electronic message is indicative of the presence of certain background events and/or interactions in the context. In this manner, the system provides a way for a user to define a context for an electronic message, in which the context includes one or more background events. The system also provides a user-friendly way for a typical user to describe the context especially when the user does not have coding capabilities to customize a source code. The user refers to a recipient and/or a sender of the electronic message, and can therefore be someone who does not have coding capabilities.

A plurality of contextual elements may share an identifier. Examples of identifiers include a name, a code, or an identification number. For example, contextual elements related to electronic messages on a non-work-related project to plan a wedding event may be assigned a project name such as “Jenny's wedding” as an identifier. Continuing with the example above, the contextual element “when is delivery” may be associated with an identifier such as a product code or a customer code. Over time as more electronic messages are exchanged on the same product, the database can include a collection of different contextual elements with the same identifier, and each contextual element is linked with a set of stickers. For the same identifier, all the sets of stickers follow the same classification scheme. In one embodiment, an electronic message processing system includes a controller coupled to a database. The database is configured to store a plurality of modules, incoming electronic messages, outgoing electronic messages, and project names. The database also stores contextual elements associated with each identifier. For each contextual element, the database is configured to store stickers in association with their respective meanings, actions taken, drafts or templates composed using the contextual elements.

In a sense, the electronic message is used to re-construct an aspect of the context to the electronic message. The re-construction is made with the aid of stickers. Using at least part of an incoming/outgoing electronic message as a contextual element, a set of stickers is associated or linked to the electronic message. The set of stickers include at least one sticker. Where the set of stickers include a plurality of stickers, the plurality of stickers is configured in a hierarchical or cascading manner. A sticker may be defined by the user at the same time as the user is applying the sticker to the contextual element. Alternatively, the sticker may be predefined before the user applies it to the contextual element. Alternatively, the system is configured to apply the sticker to the contextual element. Based on the set of stickers applied to an electronic message, the system is configured to give the user a choice of initiating a follow-up action. Based on the set of stickers and the outcome of the follow-up action, a response to the electronic message can be created and sent. Thus, having a method and system for managing electronic messages by enabling follow-up action and enabling context-responsive response to the electronic messages can increase efficiency of the user who spends several hours each day on electronic messages.

Alternatively, a sticker layer can be treated as one “layer of meaning” for describing an aspect of the context. This may be useful for gaining insight into implied meanings related to the context. Each sticker in the first layer of meaning can be linked to one of a plurality of stickers in a second layer of meaning. Each sticker in the second layer of meaning can be linked to one of a plurality of stickers in the next layer of meaning. Each sticker in one layer of meaning can be linked to one of a plurality of stickers in the next layer of meaning, that is, to a lower layer in the hierarchy, and so forth. The system can be configured to provide any number of layers of meaning. The number of layers can be determined by the user. For each layer, the system may be configured to store a plurality of stickers and, at a later time, present the stickers for the user's selection. The system is configured such that the stickers presented for the user's selection at one layer (or one sticker level) may be constrained by the sticker selected at a higher layer or a higher sticker level.

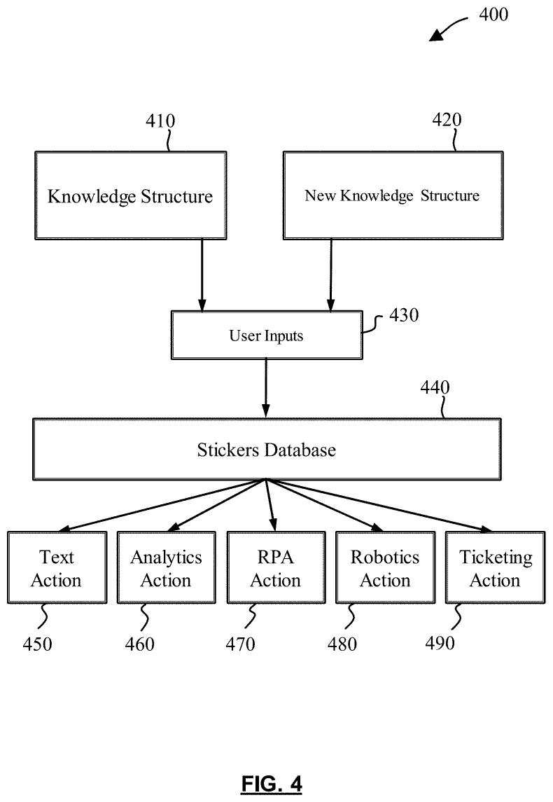

FIG. 4 shows a schematic diagram of one embodiment in which a stickering system 400 is configured to enable a user to send and/or receive electronic messages, in which the stickering system is further configured with a user interface for use by the user to build a knowledge system, in which the knowledge system contains a knowledge framework for various aspects of contexts that may be encountered in relation to electronic texts in a given environment, for example in a manufacturing situation. The context may include background events and/or interactions. The context may involve a plurality of interactions that are in turn related to background events. The context may also include previously undocumented knowledge. All this may be represented as a knowledge structure 410 or a knowledge system in a database using the stickering method as disclosed herein. Over time, this knowledge structure can be improved and adapted through user inputs 430 giving rise to updated or even new knowledge structures 420 and new stickers. The method is thus useful for creating and maintaining or updating a stickers database 440 that can be useful for users (including managers of users) to adapt to the evolving and changing business or work environment (dynamic context). When new stickers are input into the stickers database, these stickers can similarly to be used to sticker contextual elements that are identified in the various texts and be linked to actions such as, providing simple text response 450, an analytics action 460, a Robotic Process Automation (RPA) action 470, a robotics action 480, and/or a ticketing action 490; just to name a few.

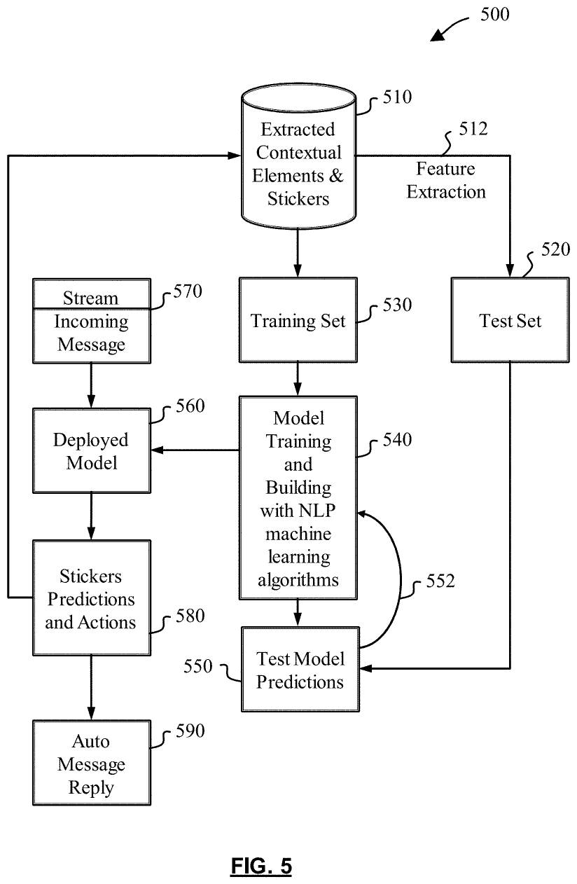

Other than allowing users to update (or create new) knowledge structures and stickers for adaptation, another embodiment to enable the current disclosure to adapt is through the employment of natural language processing (NLP) machine learning algorithms to enable changing meanings of contextual elements in texts and new and/or changed stickers to be linked to various actions. This may be the case where a machine learning module coupled to the system has acquired sufficient learning to continue adding to and using the stickers database. One embodiment of the stickering system coupled to a machine learning module 500 is schematically shown in FIG. 5.

The system and method of stickering can also serve as a framework for building in a predictive function so that the efficiency of managing electronic messages can be improved. FIG. 5 shows a stickers database 510 of contextual elements and associated sets of stickers. This data may have been developed through user input as described above. Some of the contextual elements and associated sets of stickers can form a training set 530 for building and/or training a model. Based on the database of contextual elements and stickers, feature extraction 512 is performed to provide a test set 520. At least one test set of data can be extracted from the database, and fed into a training set. The system is configured to build a model based on the training set. One example of model building involves the use of NLP machine learning algorithms 540 to parse the content of the contextual elements and/or the content of the stickers.

In one embodiment, the machine learning algorithms include algorithms to implement reinforcement learning. Reinforcement learning may include (but is not limited to) one or more of the following: supervised learning, unsupervised learning, sequence to sequence learning and classification learning. The machine learning algorithms may include algorithms configured to implement one or more artificial neural network models. Examples of the artificial neural network models include, but are not limited to: back-propagation method, Hopfield network method, self-organizing map method, and a learning vector quantization method, etc. The machine learning algorithms may include one or more deep learning algorithms. Examples of the deep learning algorithms include, but are not limited to: deep belief network method, convolutional neural network method, recurrent neural network method, stacked auto-encoder method, etc. The machine learning algorithms may include algorithms configured to implement one or more dimensionality reduction methods. Examples of the dimensionality reduction methods include, but are not limited to: principal component analysis, partial least squares regression, Sammon mapping, multidimensional scaling, projection pursuit, etc. The machine learning algorithms may include algorithms configured to implement one or more feature-extraction methods. The machine learning algorithms may include algorithms configured to implement one or more embedding-generation methods. Examples of the feature-extraction methods and/or embedding-generation methods include, but are not limited to: Continuous Bag of Words (CBOW), Skip-gram, etc. The machine learning algorithms may include algorithms configured to implement one or more ensemble methods. Examples of the ensemble methods include, but are not limited to: boosting, stacked generalization, gradient boosting machine method, random forest method, etc. The machine learning algorithms may include algorithms configured to implement one or more instance-based methods. Examples of the instance-based methods include, but are not limited to: k-nearest neighbor, self-organizing map, etc. The machine learning algorithms may include algorithms configured to implement one or more Bayesian methods. Examples of the Bayesian methods include, but are not limited to: naïve Bayes, Bayesian belief network, etc. The machine learning algorithms may include algorithms configured to implement one or more clustering methods. Examples of the clustering methods include, but are not limited to: k-means clustering, expectation maximization, etc. The machine learning algorithms may be configured to include algorithms configured to implement one or more of the following in combination: artificial neural network model, deep learning, dimensionality reduction method, feature-extraction method, embedding-generation method, ensemble method, instance-based method, Bayesian method, clustering, and other suitable methods.

Prior to deployment, the model is referred to as a training model. The test set is used to develop test model predictions 520. The test model predictions are compared against the training model. The above is iterative in what is referred to as a train/test loop process 522. When the train/test loop yields acceptable results, the model can be deployed for actual use. In a deployed mode, the system is configured to receive a stream of incoming electronic messages. These are processed with reference to the deployed model 560. The test model and/or the deployed model can be described in terms of a plurality of stickers and the relationships between the plurality of stickers. In other words, the predictions and actions are follow-up to the incoming message 570. These predictions and actions are responsive to the deployed model. The resulting stickers predictions (predicted stickers) and actions can also be used to create automatic message replies 90 that are relevant to the incoming message and to the context of the incoming message. Hence, in one aspect, embodiments of the present invention can help to improve machine learning of the context of electronic messages (or electronic text, as the case may be). They can also involve initiating one or more follow-up actions responsive to the context of the electronic message. Embodiments of the present invention therefore help to address technical problems such as how to determine a relevant and/or appropriate response to an electronic message. Addressing such technical problems can be useful in the development of artificial intelligence bots, among other applications and use.

The above can also be described as part of a learning mode (learning manual mode or learning suggestion mode) of a stickering system which is configured to enable a user to build up a knowledge system using electronic texts, in which the stickering system provides for user customization to build up different knowledge systems suitable for managing projects or for managing electronic interactions. As the user performs the method under the learning mode (learning manual mode or learning suggestion mode) on a plurality of electronic texts, the user will be adding to the knowledge system. The knowledge system will evolve to reflect the user's domain knowledge and experience related to the project. As the user performs the method under the deployed mode on electronic messages related to different projects, the knowledge system will evolve to reflect the user's domain knowledge and experience on various types of projects, and thereby enable more efficient management of projects and/or interactions. It can be appreciated that the knowledge system will reflect a certain degree of customization or subjectivity because it is contributed to at least in part by one or more users who may have different perspectives of the context behind the electronic texts. The users can include and are preferably (although not limited to) ordinary creators and/or recipients of electronic texts (including electronic messages).

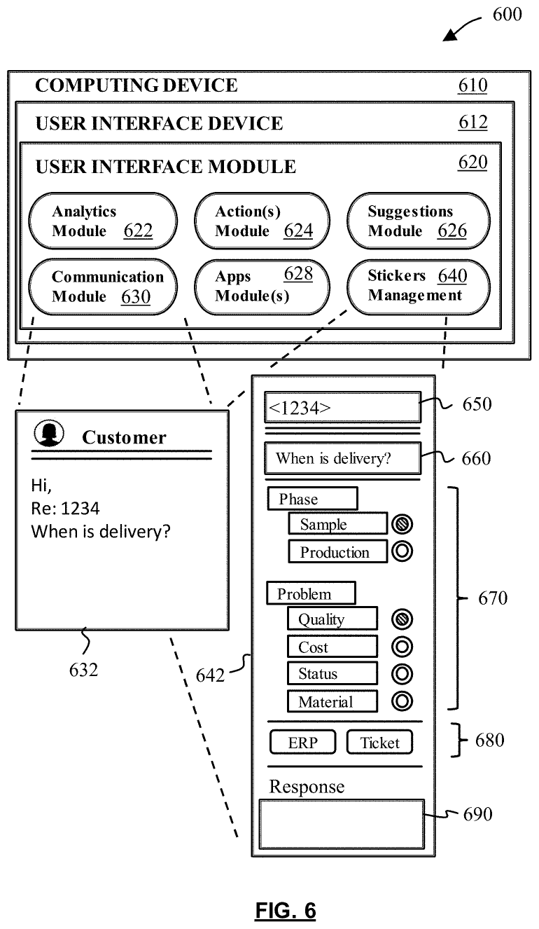

FIG. 6 is another schematic diagram of one embodiment of a stickering system 600 in which a user interface device 612 is configured to provide a user interface module 620, and in which the user interface device is coupled to a computing device 610. The computing device may include a user interface device which is configurable to present the user with access to a plurality of modules. The plurality of modules may be enabled by a stickers database coupled to the computing device. The plurality of modules may include, for example, an analytics module 622, at least one action module 624, a suggestions module 626, at least one apps module 628, a communication module 630, and a stickering module 640, etc. A communication module may be configured to present the user with an electronic message client user interface for reading and/or writing electronic messages. The user interface may include an electronic message client interface 632. The electronic message client interface may be configured as a plurality of meshed intelligent panels. The user interface module may be further configured to present a stickering tool 642 in the form of a user interface, within the environment of the electronic message client user interface. The user interface module may be further configured with a stickers management module. The stickers management module may further enable the user to define a hierarchical order to the stickers (such as the example described above with reference to FIG. 3) or to predefine stickers at various sticker levels. The stickers management module may be configured so that the user may define a plurality of stickers in a cascading tree or hierarchical order with respect to one another.

The stickering system is configured to provide the user with a stickering tool under certain conditions. For example, the contextual stickers module may be configured to provide the user with the stickering tool when the communication module is used to read and/or write an electronic message. The stickering tool may be presented to the user in the form of a contextual menu when the user input device hovers or mouses over a pre-defined area in the user interface. The stickering tool may be presented to the user in the form of a floating window. The stickering tool may be presented to the user as part of the electronic message client, for example, as an extension module installed to work with the email client.

In the example illustrated, with respect to an identifier 650, the stickering tool 642 provides the user with the ability to link a contextual element 660 with a set of stickers 670, and also to an action 680.

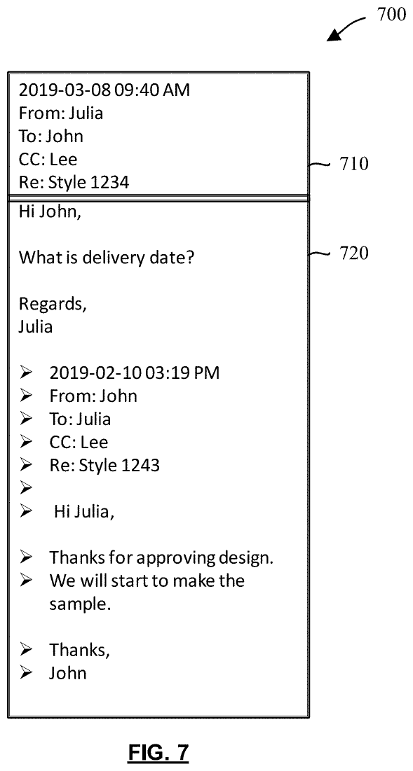

According to one embodiment, an electronic messaging system is operable by a user to receive and/or send an electronic message, and the electronic messaging system is configured to present the user with the stickering tool, in which the stickering tool enables the user to select a content from the electronic message as a contextual element, and to associate the contextual element with at least one sticker. In this document, “content” refers to data or information that is carried by an electronic message 700 (FIG. 7). This includes data and/or information in the message body of the electronic message and/or in the message header of the electronic message. The message header may include an address and/or subject line of the electronic message 710. The message body includes content written or otherwise provided by the user in composing the electronic message 720. In this document, the message body also includes any file attachments, an aspect of the file attachment, and/or contents of the attachment file. Embodiments of the present disclosure includes a non-transitory computer-readable storage medium having computer-executable code for enabling a method of project management. This can be described using an example in which there is interaction between two parties in relation to a project, and in which the interactions include an exchange of electronic messages. It will be understood that other forms of electronic messages may also be used, and emails are used here just for the sake of illustrating an example. The emails may be exchanged via a network through the use of email clients. In accordance with one embodiment of the system, the system provides a stickering tool as part of an email client. When a user uses an email client to receive an email, the stickering tool may be presented to the user in the form of a user interface.

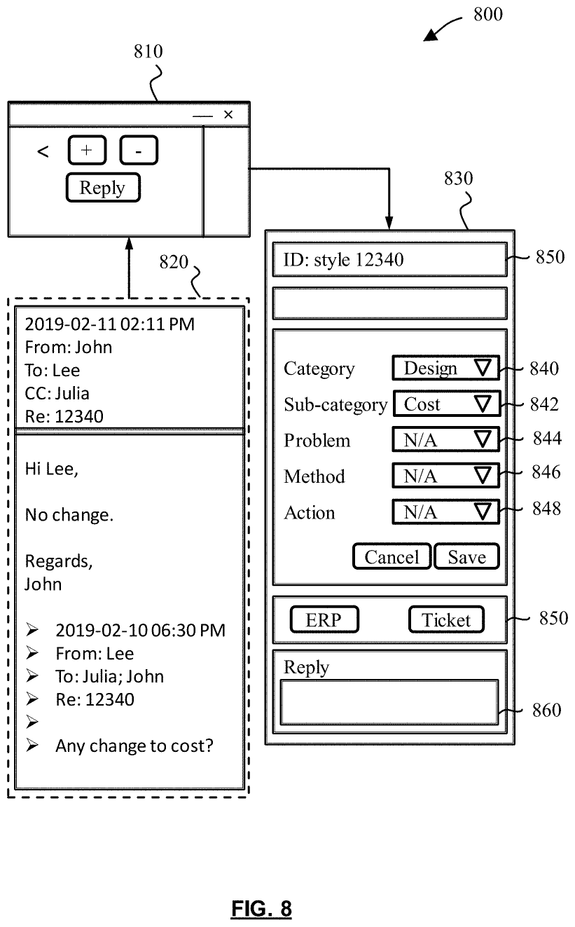

As schematically illustrated in FIG. 8, one embodiment of the stickering tool 810 may be configured to enable the user to select an entire electronic message 820, such as an email, as one contextual element, and to link the contextual element to a set of stickers 830. In a learning suggestion mode, the stickering tool may be configured to suggest selecting the entire email as one contextual element, that is to say, content in the header and content in the body are together selectable as one contextual element. In an automatic mode, the stickering tool may be configured to automatically select the entire email as one contextual element, based on the knowledge system acquired through prior learning and training.

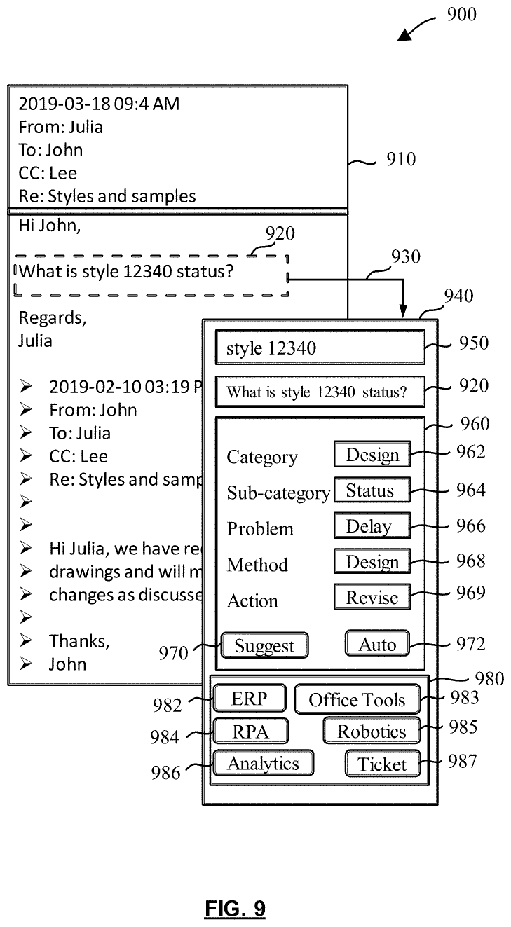

An email can be described as having a header and a body, in which the header includes content giving information on the sender and at least one recipient of the email, and in which the body includes content that can be in the form of words, images, and/or file attachments. The stickering tool may be configured to enable a method in which the user may select a part of the email as one contextual element 900 (as shown in FIG. 9). The stickering tool 940 may be configured to enable the user to select a content 920 from the email 910 and to use the selected content as a contextual element, and to link 930 the contextual element to a set of stickers 960. In a learning suggestion mode, the stickering tool may be configured to suggest selecting a content from the email as one contextual element. In an automatic mode, the stickering tool may be configured to automatically select a content of the email as one contextual element, based on the knowledge system acquired through prior learning and training.

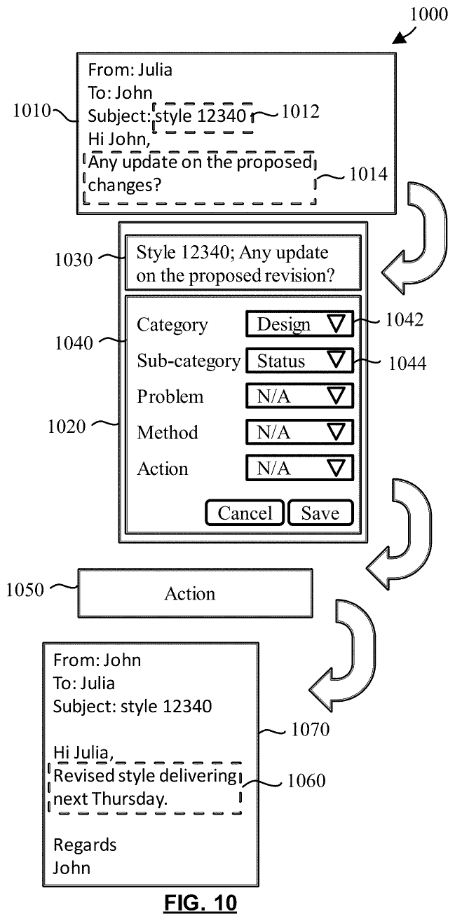

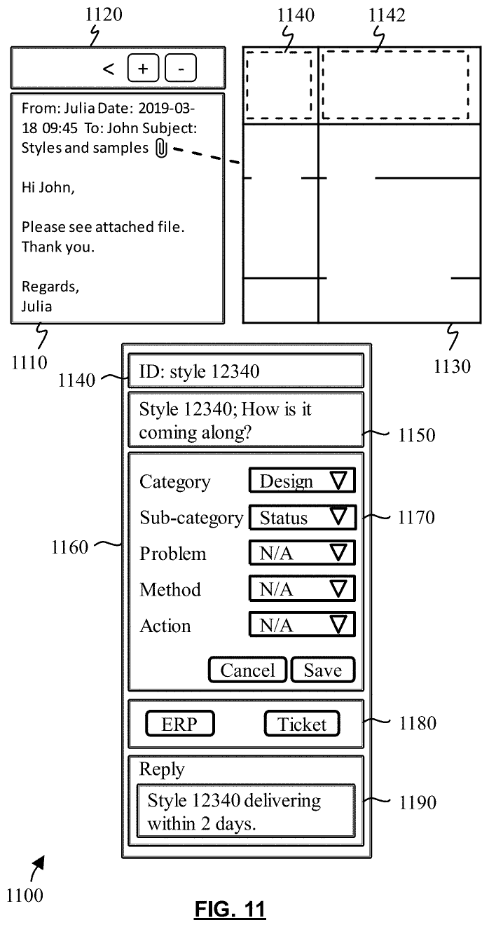

For example, the stickering tool is configured to enable the user to select content in the header 1012 as one contextual element. The stickering tool is configured to enable the user to select content in the body 1014 as one contextual element. The stickering tool is configured to enable the user to select a part of the header 1012 and a part of the body 1014 as one contextual element 1030 (as shown in FIG. 10). For example, the stickering tool is configured to enable the user to select a word, a phrase, a sentence, a paragraph, an image, an audio recording, a file, and/or a plurality of any of these, as a contextual element. This list is not intended to be exhaustive, and is mentioned here only for the purpose of giving examples to aid understanding. For example, the stickering tool is configured to enable the user to select a file attachment 1130 as one contextual element 1150. In another example, the stickering tool is configured to enable the user to select content 1140, 1142 in the file attachment as one contextual element 1150 (as shown in FIG. 11).

The stickering tool is configured to enable the user to select more than one contextual element from one email. The stickering tool is configured to enable the user to select more than one contextual element from the header, in which one part of the content in the header is selectable as one contextual element and another part of the content in the header is selectable as another contextual element. The stickering tool is configured to enable the user to select more than one contextual element from the body, in which one part of the content in the body is selectable as one contextual element and another part of the content in the body is selectable as another contextual element. The stickering tool is thus configured to enable the user to define a contextual element using an electronic message as a source of possible contextual elements.

In one embodiment, the manner in which aspects of the context are organized for the purpose of stickering is definable by a user, so that the user's perspective may be reflected in the knowledge system created and/or maintained by the stickering method and system. This provides the stickering system with the flexibility to evolve as the context changes or as the user's perspective of the context changes. The dynamic nature of the context can be reflected by one or more stickers used in linking to a contextual element.

Referring again to FIG. 8, the embodiment schematically illustrated here includes a stickering method of defining at least one aspect (of a context), for example a “category” 840. The embodiment includes a stickering system configured such that a user can define at least one “category”. In one example, a user can define a number of “categories” for use in describing a corresponding number of different phases of a project. For instance, the user can choose to define three categories: “design”, “production”, and “delivery”. To the user, there are certain background events and/or interactions that are related to the “design” category, some other background events and/or interactions that are related to the “production” category, and yet other background events and/or interactions that are related to the “delivery” category. The user may define the “categories” using a user interface provided by a stickering system. In some examples, “categories” may be defined in terms of phases. “Categories” may be defined so that there is a plurality of chronologically ordered “categories”. In one example, a project includes a prototype phase, a volume ramp-up phase, and a manufacturing phase; the user may configure the stickers database so that stickers “prototype phase”, “ramp-up phase”, and “manufacturing phase” are available for use in linking to a contextual element. In another example, a project includes a work performance phase. The stickering system may be configured to have only one possible sticker for use in linking, in which the sticker corresponds to the work performance phase. In yet another example, a project includes a service order phase, a service performance phase, and a payment phase. Milestones can be used to mark the transition of one phase into another phase. A milestone may mark the end of an earlier phase and the beginning of the next phase. Each of these phases may be mapped to one or more background events and/or interactions. When the user links a contextual element from the email message to the corresponding phase, milestone, or corresponding background event of the project, the stickering system can learn to track the progress of the project.

To aid understanding, the following describes one example of a stickering tool as used in a situation where the user is a recipient of an electronic message, although the stickering tool is applicable where the user is a sender of an electronic message. The stickering tool is also applicable in situations where the contextual element is based on an electronic text that is not an electronic message.

Referring to FIG. 8, when an electronic message 820 is received, the stickering system 800 proceeds to perform one or more steps selected from the following possible steps: determining an identifier 850; selecting a contextual element 820 associated with the identifier; linking the selected contextual element with one or more stickers 840, and in a case where there is a plurality of stickers, the plurality of stickers are organized in layers (sticker levels). Where applicable, the stickering system initiates an action to retrieve an answer. Upon receipt of the answer, the stickering system uses the answer when composing a response in the form of an electronic message. The steps described herein need not be performed in the order presented above, and need not begin with the first step listed above.

From the electronic message received, the system determines the identifier, which in this case can be a project name, a style number, a sample number, a customer's name, etc. The project name may be a convenient reference for a conversation or a project. The project name may be a user-defined identification for one conversation out of multiple conversations relating to one project. In the example of FIG. 8, the project name is “style 12340”.

In this example, there are sticker levels associated with each contextual element. As shown in the stickering tool in FIG. 8, there is a first layer named “Category” 840, a second layer name “Sub-category” 842, a third layer named “Problem” 844, a fourth layer named “Method” 846, and a fifth layer named “Action” 848. These sticker levels may have been predetermined in the administrative settings by a user using an administrative interface. The number of stickers available at each sticker level may be controllable in the administrative settings. The stickers available at each sticker level are preferably initially constrained to predetermined values, for example, with the predetermined values determined at an administrative interface. The user may be permitted to create new stickers at the user interface 810. Alternatively, the user may be permitted a mixture of constrained and unconstrained options. As the stickers database grows through use of the stickering method, the stickers available at each sticker level may adaptively change to suit the jargon/vocabulary of the user.

In the user interface shown, the stickers that may be used at each sticker level may be selected by a user through a series of dependent drop-down lists or menus 840, 842, 844, 846, 848. There may be different numbers of stickers available at the various sticker level, each sticker level corresponding to an aspect of the context or to a layer of meaning in the hierarchy. Each of these stickers refers to a possible aspect of the project named “style 12340”. In this example, the sticker level corresponding to a phase of the project is referred to as a primary list upon the other drop-down lists are dependent. Alternatively described, the stickers associated with one contextual element can be selected from a series of cascading lists of stickers.

Referring to FIG. 9, the options of stickers in one sticker level may be configured to depend on the sticker selected in the preceding sticker level. For example, if the sticker “Design” is selected for the first sticker lever “Category” 962, the stickers available in the next sticker level “Sub-category” may include: “Status” 964. This in turn constrains the options of stickers in the subsequent sticker level “Problem” to include: “Delay”, “No Change”, and “Ahead of Schedule”. If the sticker “Delay” is selected 966, the options of stickers in the next sticker level “Method” may be constrained to “Design”, “Tooling”, and “Packaging” 968. There may be another sticker level 969 if so applicable. In this example, a contextual element 920 may be linked with as many as five stickers in a set of stickers 960, in which the five stickers are selected from cascading or dependent lists. In other examples, a contextual element may be linked with a different number of stickers, in which the stickers are ordered according to a hierarchy corresponding to a hierarchy of stickers.

The stickering system 900 may be configured so that a parser is deployed to extract from the electronic message 910 such elements such as a contextual element 920 and/or an identifier 950. The stickering system may be configured to operate in a learning manual mode, or a learning suggestion mode 970, or an automatic mode 980. Although the user interface 940 may provide for as many as five stickers to be linked with one contextual element, it is permissible to link fewer than five stickers with the contextual element. For example, in FIG. 8, the contextual element is linked to a set of stickers having fewer than five stickers. The set of stickers applied include “Design” in the first sticker level of “Category”, and a sticker of “Cost” in the second sticker level of “Sub-category”. The lower sticker levels are left unused. This may take the form of the contextual element being linked to two stickers, or it may take the form of the contextual element being linked to five stickers of which three stickers are “null” or dummy stickers. In the user interface, the layers “Problem”, “Method”, and “Action” are shown as “N/A” (“not applicable”) merely for illustrative purpose.

Continuing with FIG. 9, based on the selected contextual elements and associated stickers, the stickering system may initiate one or more follow-up actions, such as a data retrieval from another data management system (which will be referred to in this document as ERP (enterprise resource planning) system for convenience, although not limited to such) 982 or a ticketing event 987. The stickering system may be configured to initiate actions such as executing an RPA, running office tools, carrying out certain robotics functions, performing data analytics, and/or initiating a ticket. Other action modules may be coupled to the stickering system for similar cooperation, such as an accounting system, manpower planning system, tax and regulatory clearance systems, logistics planning, etc.

Referring to FIG. 10, in response to receiving a first electronic message 1010, a part of the content of a first electronic message (“any update on the proposed revision?”) 1014 can be linked to the project name “style 1234” 1012, and thus the related conversation can be identified from the first electronic message. The stickers “Design” 1042 and “Status” 1044 are linked to this contextual element. It can be appreciated that the contents of the electronic message can be correctly “understood” because the same combination of stickers would have applied to a differently worded sentence with a similar meaning would be similarly linked even when the contents of the message contains typographical errors, grammatical errors, and/or other variations arising from use of dialect, jargon, and/or other languages.

If the user (the recipient of the first electronic message) is able to respond to the first electronic message, the user may choose to compose and send a second electronic message directly in the user interface provided 860 (FIG. 8) or as a message composed using a suitable client or app 1070 (FIG. 10).

Alternatively, based on earlier learning gained through the architecture of FIG. 4 and FIG. 5, the system can be configured to trigger an action 1050 intended to provide an answer 1060 which can be used to in a response 1070 to the query. This may involve gathering input from other coupled systems and/or databases, responsive to the stickers. Previous similar situations where an electronic message with a contextual element linked to stickers “Design” and “Status” had led to an action in the form of a query being sent to an ERP system to retrieve a status update. This was previously captured by the stickering method and system. Accordingly, in this instance, in response to the stickers “Design” and “Status” being linked to a contextual element in this first electronic message, the system can apply the earlier learning and retrieves an appropriate answer from the ERP system.

In response to receiving the answer in the form of a status update from the ERP, the stickering system can be configured to suggest a response to first electronic message in a user interface. The user has an option of editing the suggested response before sending it to the other party. Alternatively, the stickering system can be configured so that, in response to receiving the status update from the ERP, the stickering system automatically generates and sends out a second electronic message in reply to the first electronic message. The stickering system can thus keep track of both the progress of the project as well as a history of what has been communicated in the conversation pertaining to the project named “style 12340”. This avoids a situation where a user (in this case, such as a recipient of the first electronic message) has to spend time seeking a status update to a project when the information has already been captured in another system in the organization. When there is a high volume of work and electronic messages being dealt with every day in an organization, deploying an embodiment of the present system and/or method can facilitate greater efficiency and make better use of resources.

In some cases, the required data and/or information is not available from documented or recorded data and/or information. In one example, the status of the project “style 12340” is requested before the ERP is updated. According to one embodiment, the stickering system is configured to initiate an action in the form of a “ticket” from a first user to a second user. In a ticket-related action, a request is sent to the second user to perform a task for the purpose of obtaining an answer. The action may include asking the second user to provide an answer (in this case, a status update of the project “style 12340”). In response to the first user receiving the answer (in the form of a status update) from the second user, the system can suggest a response to first electronic message based on the answer. Alternatively, the system can automatically generate and send out a second electronic message in reply to the first electronic message. The system can also update the ERP system with the updated status. The system can thus keep track of both the progress of the project as well as a history of what has been communicated in the conversation pertaining to the project named “style 12340”.

For the purpose of this disclosure, the body of an electronic message 1110 includes any file attachments 1130 and/or contents 1140, 1142 of the file attachments. This is illustrated schematically in FIG. 11. In this example, an electronic message 1110 received and is found to be attached with a spreadsheet. The system is configured to read the contents of the spreadsheet, for example, using a parser. From the contents of the spreadsheet, a contextual element 1150 is determined on the basis of two cells respectively containing a project name “style 12340” 1140 and a question “How is it coming along?” 1142. The contents of the file attachment can be extracted to populate respective fields of the stickering tool 1120, 1160. A user interface 1160 may not be necessary in this mode since the stickering system can be configured to determine the relevant contextual elements. The stickering system can also be configured to determine relationships between contextual elements and the sets of stickers.

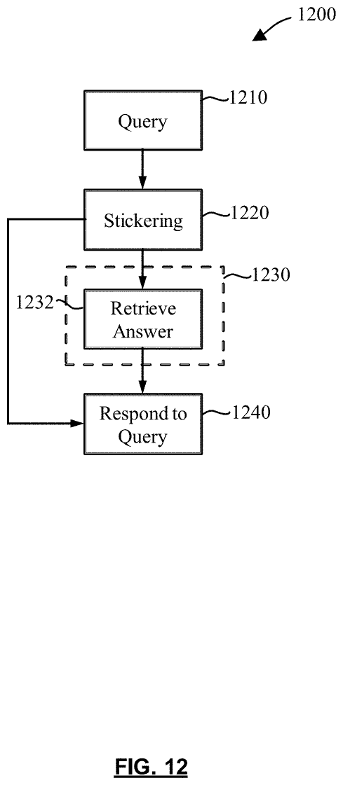

FIG. 12 further illustrates a stickering system and method 1200 in which a query 1210 leads to a stickering 1220 of a contextual element, a set of stickers, and an action 1230 to define a relationship. As an example, the action may include retrieving an answer 1232 suitable for forming a response 1240 to the query.

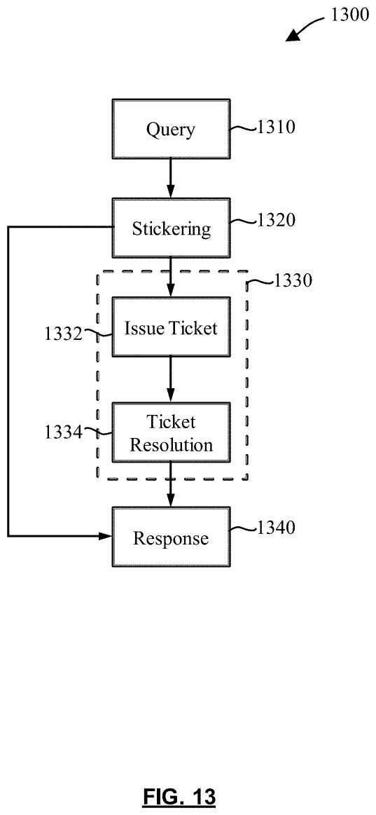

FIG. 13 further illustrates a stickering system and method 1300 in which a query 1310 leads to a stickering 1320 by which a contextual element, a set of stickers, and an action 1330 in a relationship are linked. As an example, the action may include issuing a ticket and resolving the ticket when an answer is provided for responding 1340 to the query.

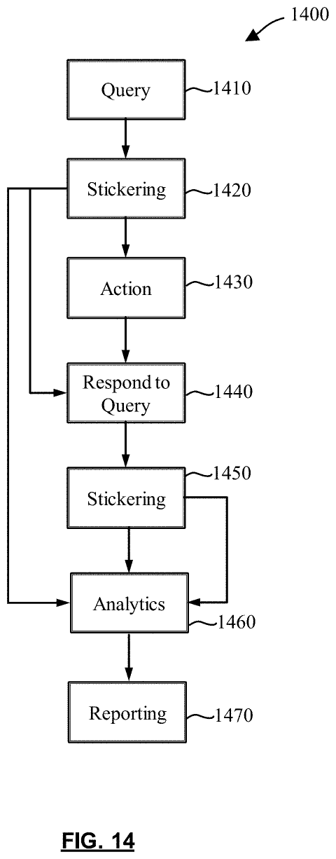

FIG. 14 further illustrates a stickering system and method 1400 in which a query 1410, an action 1430 and a response 1440 are captured by stickering 1420, 1450, and fed into the analytics 1460 and reporting 1470 module mentioned above.

In one embodiment, the data captured by the system can be used to give insight into the type of interactions in the context behind the electronic messages. For instance, it is possible to have insight into the number of actions and the type of actions performed in each category or phase of a project. In another example, the system can also provide insight on which customer has negotiated the hardest on pricing. The system can also be tied to an accounting module so that payments and receipts can be analyzed according to the specific product model, and form the basis of future marketing plans.

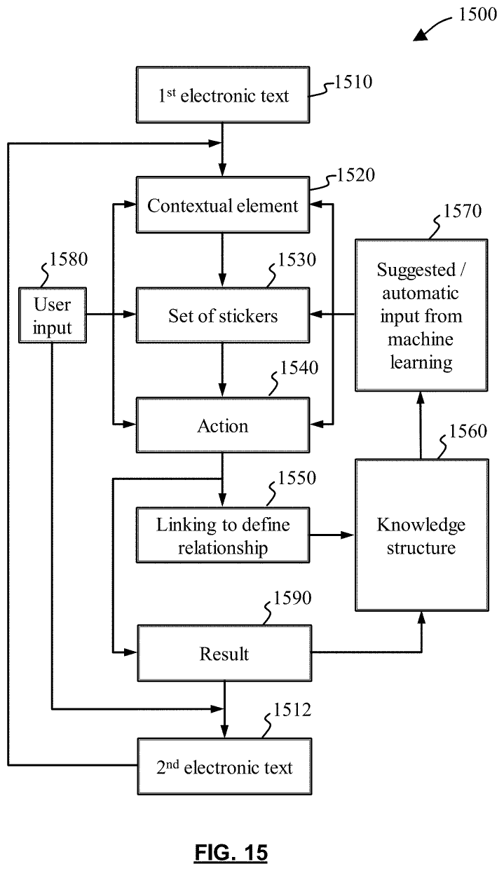

Referring to FIG. 15, there is provided an embodiment of a method 1500 implementable by a computing device having a computer-readable medium carrying computer-executable code, the method involving determining a contextual element 1520 in at least a part of an electronic text 1510; linking a set of stickers 1530 with the contextual element and an action 1540 to define a relationship 1550; and configuring a knowledge structure 1560, in which the knowledge structure is configurable by storing the relationship in a stickers database coupled to the computing device.

The knowledge structure may be re-configurable by storing an updated relationship in the stickers database. The embodiment may include providing a user interface configured to enable a user to re-configure the knowledge structure 1560 by: defining the updated relationship; and storing the updated relationship in the stickers database. The computing device may be further configured to suggest a candidate relationship, in which the candidate relationship is defined using a model trained by a plurality of relationships stored in the stickers database 1570. The candidate relationship may be drawn from a model trained with a plurality of contextual elements associated with a plurality of relationships stored in the stickers database. The model may include an NLP model. The computing device may be further configured to define the updated relationship using a model trained by a plurality of relationships stored in the stickers database 1570. The computing device may be configured to define the updated relationship, and the updated relationship may include a partly or wholly reconfigured plurality of relationships stored in the stickers database. The updated relationship may be drawn from an NLP model trainable by a plurality of relationships stored in the stickers database. The NLP model may be further trainable by the updated relationship. The embodiment may include determining the set of stickers 1530 so that each sticker of the set of stickers is associated with a different sticker level, wherein the set of stickers includes one or more stickers, each of the one or more stickers corresponding to an aspect of a context related to the electronic text. The set of stickers 130 may further include a plurality of stickers configured in a hierarchy of sticker levels. The embodiment may include storing the set of stickers as a persistent property of the linked contextual element in the stickers database. The embodiment may include: initiating the action to answer 1590 a query, the query being at least a part of the contextual element.

Referring to FIG. 15, there is provided an embodiment of a method 1500 implementable by a computing device having a computer-readable medium carrying computer-executable code, the method involving: using at least a part of a first electronic text 1510, determining a contextual element 1520; determining a set of stickers 1530 corresponding to a perspective of a context of the first electronic text; linking the contextual element with the set of stickers and an action to define a relationship 1540, 1550; and storing the relationship in a stickers database representing a knowledge structure 1560, in which the storing of the relationship modifies the knowledge structure.

The method may further include: using input from a machine learning module 1570 to determine at least one of the following: the contextual element, the set of stickers, and the action, wherein the machine learning module is coupled with the stickers database such that the input is determined by the knowledge structure 1560. The method may further include: using input from a machine learning module to determine the relationship 1550, wherein the machine learning module is coupled with the stickers database such that the input is determined by the knowledge structure 1560. The method may further include: using a further input from a user interface 1580 to modify the input from the machine learning module, wherein the user interface is coupled with the stickers database such that the knowledge structure 1560 can be further modified by the further input from the user interface. The method may further include: using input from a user interface 1580 to determine at least one of the following: the contextual element, the set of stickers, and the action, wherein the user interface is coupled with the stickers database such that the knowledge structure 1560 can be modified by the input. The relationship 1550 may further include updating the relationship by using input from a machine learning module to change at least one of the contextual element and the set of stickers. The set of stickers 1530 may include at least one sticker, each of the at least one sticker being associated with a respective sticker level in a hierarchy of sticker levels. The method may further include: determining the action, in which the action is determined in part by the set of stickers; using a result of the action to form a second electronic text; using at least a part of the second electronic text, determining a second contextual element; determining a second set of stickers; linking the second contextual element with the second set of stickers to define an updated relationship related to the action; and modifying the knowledge structure by storing the updated relationship. The method may further include parsing the contextual element using natural language processing. The embodiment may include the first electronic text being an electronic message; and in which the contextual element is determined from: at least a part of a message header of the electronic message, at least a part of a message body of the electronic message, at least a part of the message header and at least a part of the message body of the electronic message, or the electronic message as a whole.

Referring to FIG. 15, there is provided an embodiment of a system 1500 operable by a user to manage electronic texts, the system including: a user interface 1580; a stickers database configured as a knowledge structure, 1560 the stickers database being coupled to the user interface so that the knowledge structure; and a computing device coupled to the stickers database and the user interface, the computing device being configured to: use at least a part of a first electronic text 1510 to determine a contextual element 1520; determine a set of stickers 1530 corresponding to the user's perspective of a context of the first electronic text; the set of stickers including at least one sticker, each of the at least one sticker being associated with a respective sticker level in a hierarchy of sticker levels, the hierarchy of sticker levels being configurable by the user through the user interface 1580; link the contextual element with the set of stickers to define a relationship related to an action 1540, 1550; and store the relationship in the stickers database, wherein the knowledge structure is modified by the relationship stored in the stickers database 1560, and in which the knowledge structure is configurable by the user providing input through the user interface 1580.

The system may be configured in which the knowledge structure is configurable by the user providing input through the user interface 1580 to determine the contextual element. 1520. The system may be configured in which the knowledge structure is configurable by the user providing input through the user interface 1580 to determine the set of stickers 1530. The system may be configured in which the knowledge structure is configurable by the user providing input through the user interface 1580 to link the contextual element with the set of stickers 1550. The system may be configured in which the knowledge structure 1560 is configurable by the user providing input through the user interface 1580 to determine the action 1540.

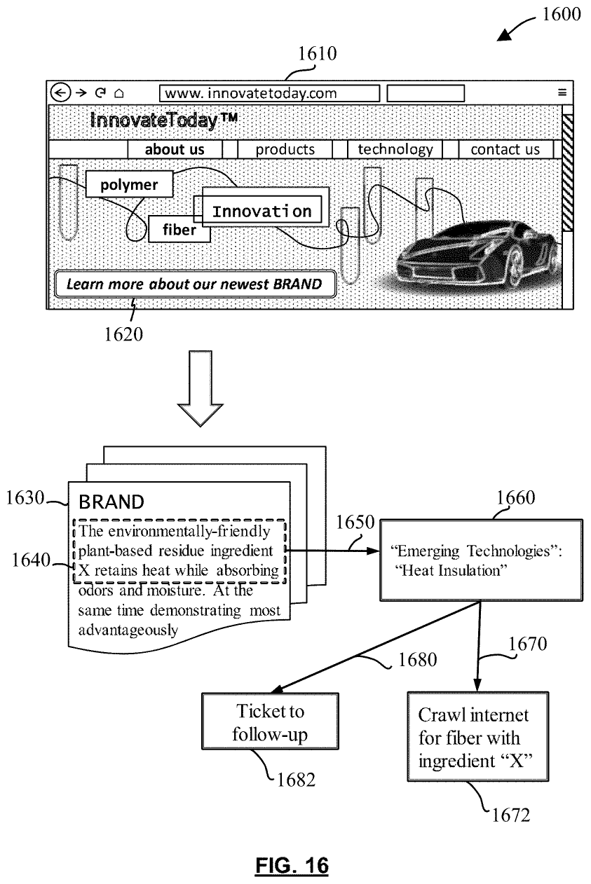

To aid understanding, another embodiment of the present disclosure will be described with reference to FIG. 16. The stickering system is configured so that a first user (for example, a managing director of a garment manufacturer) can use the stickering method 1600 to drive strategic investments and direction for the organization. To illustrate, the first user, upon visiting a website using a browser app on a first user interface 1610, accesses an electronic text (such as a PDF document or another web page) through a link 1620. In this example, the first user reads about a new type of fabric made from new fibers with superior heat insulation properties. The first user may attach, link or otherwise share the electronic text with other users.

Using a stickering tool provided by the stickering system, the first user can determine at least a part of the electronic text 1630 as a contextual element 1640. In this example, “the environmentally-friendly plant-based residue ingredient X retains heat” is selected as a contextual element. Here, the first user uses the stickering tool to link 1650 the contextual element to a set of stickers 1660 (“emerging technologies: heat insulation”), thereby reflecting the first user's subjective perspective that the context behind the electronic text is related to emerging technology of potential strategic implication to the organization. It can thus be appreciated that the stickering system provides a user to incorporate a subjective perspective of the context behind the electronic text. This means that the same stickering system may be used by a second user accessing the same text to link the same contextual element to a different set of stickers. For example, a designer of the same organization may be focused on a different perspective and thus link the same contextual element to a set of stickers reflective of the different perspective, such as “design: eco fabric”.

Additionally, the stickering system may be configured such that, upon a set of stickers including “emerging technologies” is linked to a contextual element, a link 1670 to an action 1672 in the form of an RPA process is triggered. The RPA may be configured to automatically crawl the internet and various electronically accessible knowledge depositories to search and consolidate relevant articles and information on the ingredient “X”. As the RPA collects additional relevant electronic texts, the additional relevant electronic texts may be processed by the stickering system so that the knowledge structure grows. When sufficient contextual elements have been linked to sets of stickers, the stickering system would have acquired or learned the relevant words and text associated with the sets of stickers related to heat insulation technologies. Hence, when another related electronic text is accessed, the stickering system can link the relevant contextual elements with related sets of stickers, and in turn link to relevant actions, such as follow-up tickets and/or RPA actions.

The stickering system may be further configured to link more than one action to a set of stickers linked with a contextual element. The respective actions may occur simultaneously or at different times. In this example, the first user concurrently uses the stickering system to link 1680 to an action 1682 involving creating a ticket to a special projects team. The ticket action may involve getting an answer to one or more queries, such as “what are the available sources of the new fiber” and “can the new fiber be used in making the organization's products”. In this manner, the stickering method and system can be an improved way of managing and/or using information to drive strategic development in an organization.

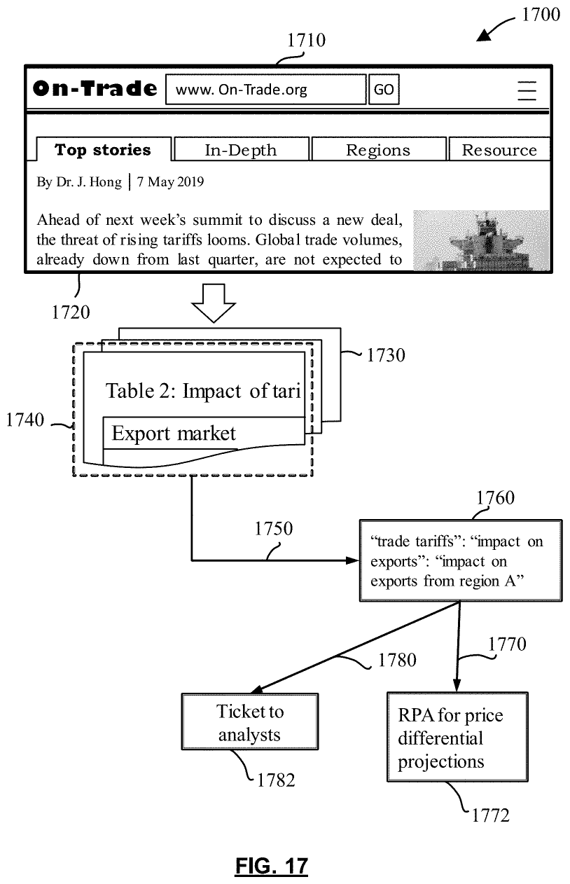

FIG. 17 illustrates another application of an embodiment of the stickering method and system 1700. In this example, a user accesses an article 1720 over the internet using a user interface 1710. The user may be a senior management, such as a finance director of an organization. The article may provide one or more electronic text in the form of commentary, graphics, videos, audio recordings, documents, and/or links to other electronic texts 1730. From the website, the user may select a file to download, such as a portable document format (PDF) document on trade tariffs. Within the PDF document, the user may find information of interest, for example, analyses on the impact of tariffs on multiple markets relevant to the organization. The stickering method and system enables the user to follow up on the information of interest by selecting it as a contextual element 1740.

In one embodiment, the stickering method and system is configured such that, if the user electronically shares the PDF document with one or more recipients (who may include the user himself/herself), at least one set of stickers will be provided to the one or more recipients. The email client of the recipient may be configured to launch or otherwise present a stickering tool 1750 upon receipt of an email with at least one attachment. The user can thus select one or more parts of the PDF document to serve as one or more contextual elements. The user can also link the one or more contextual elements with one or more sets of stickers 1760. Once the user has linked at least a part of the attachment with at least one set of stickers, the information of interest embedded within the attachment is captured for contribution to the knowledge structure, together with the user's perspective of the information of interest. This perspective may be one of the potential implications of the information of interest. Conventionally, “context” is sometimes used to refer to measurable attributes, such as temperature, or to other parts of the electronic text. Thus, it can be appreciated from this and other examples that the scope of “context” of an electronic text as used in this document goes beyond the conventional.

In one example, a top level sticker may be “trade tariffs”, and descending levels of stickers may be “impact on exports from region A”, “impact on Region B exports”, etc. This layered and hierarchical stickering may be performed by the user or by other recipients of the shared electronic text. In this manner, the user can highlight contextual elements of importance (to the user) and stickers. The stickering system is configured such that, responsive to a linkage being formed between a contextual element and a set of stickers, one or more actions is linked thereto 1770, 1780. These linkages then trigger one or more actions, for example, a RPA process 1772 to make price differential projections, or to search and consolidate relevant articles on product price differentials between different markets as a result of the trade tariffs. Alternatively, or additionally, a resulting action 1782 may be a ticker to a team to follow up with further analysis and proposals for mitigating potential impact from the trade tariffs.

When sufficient contextual elements have been linked (or stickered), the stickering system would have learned the relevant text (e.g., words, phrases, character strings, etc.) that are associated with stickers related to trade tariffs. Hence, when another related electronic text is received in an in-box of the organization using and/or building the knowledge structure, the stickering system can be configured to automatically link the appropriate sets of stickers by selecting from words previously associated with trade tariffs. The stickering system would thus be able to link with the relevant actions by selecting from actions previously associated with such sets of stickers. In this example, the relevant actions may include triggering RPA actions to further crawl the internet for more recent articles on trade tariffs.

Thus, as can be understood from the above description and the accompany drawings, embodiments of the present disclosure can realize practical advantages in helping people more efficiently respond to electronic messages. The embodiments can help ensure that projects are properly monitored and managed. The embodiments also address practical challenges and prepare a foundation for “smarter” analytics, artificial intelligence bots and related technologies.

Thus, it can be appreciated that the present disclosure provides a stickering system operable by a user to manage electronic texts, the system including: a user interface; a stickers database configured as a knowledge structure, the stickers database being coupled to the user interface so that the knowledge structure; and a computing device coupled to the stickers database and the user interface, the computing device being configured to: use at least a part of a first electronic text to determine a contextual element; determine a set of stickers corresponding to the user's perspective of a context of the first electronic text; the set of stickers including at least one sticker, each of the at least one sticker being associated with a respective sticker level in a hierarchy of sticker levels, the hierarchy of sticker levels being configurable by the user through the user interface; link the contextual element with the set of stickers to define a relationship related to an action; and store the relationship in the stickers database, wherein the knowledge structure is modified by the relationship stored in the stickers database, and in which the knowledge structure is configurable by the user providing input through the user interface.

A method including: presenting a user interface, in which the user interface is configured to enable a user to define a contextual element in an electronic text; and for every contextual element: linking the contextual element to at least one sticker; and storing at least one sticker as a persistent property of the contextual element. The method above, further including, for every contextual element, linking the contextual element to a set of stickers, in which the set of stickers includes a plurality of stickers; and storing the set of stickers as a persistent property of the contextual element. The method above, in which each of the stickers in the same set of stickers can be associated with one of a plurality of sticker levels, and in which the plurality of sticker levels is configured as a hierarchy of sticker levels. The method above, in which the user interface is further configured to enable the user to define the hierarchy of sticker levels. The method above, in which a sticker associated with one of the sticker levels and the sticker describes an aspect of a context behind the electronic text. The aspect of the context may be one of a plurality of chronological background events. The method above further including: in response to the set of stickers including a predetermined sticker, initiating an action to, for example, retrieve an answer; and using the answer in a response specific to the contextual element. The action may include: presenting an application interface; and recording keystrokes input received through the application interface to enable the above methods. The action may include: retrieving an answer from a database comprising contextual elements, each contextual element being linked to a respective set of stickers. The action may include: requesting a task to be performed automatically by integrated systems or at least by another user so as to obtain the answer and respond with respect to the contextual element.

An electronic message-based system configured to enable a method of managing the system, the system including a computing device configured to provide a user interface, in which the user interface is configured to: enable a user to define a contextual element from a first electronic message; and link a set of stickers to the contextual element; and a database coupled to the computing device, the database being configured to store the set of stickers as a persistent property of the contextual element. The system above, in which the set of stickers may include a plurality of sticker levels, and in which the plurality of sticker levels is configured as a hierarchy of sticker levels. The system above, in which the system is further configured to initiate an action to obtain an answer; and to use the answer in a response to the first electronic message. The system above, in which the system is further configured to retrieve an answer from the database.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments have been chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be effected therein by one skilled in the art without departing from the scope of the disclosure.

1. A method implementable by a computing device having a computer-readable medium carrying computer-executable code, the method comprising:
determining a contextual element in at least a part of an electronic text;
linking a set of stickers with the contextual element and an action to define a relationship; and
configuring a knowledge structure, wherein the knowledge structure is configurable by storing the relationship in a stickers database coupled to the computing device.

2. The method of claim 1, further comprising: providing a user interface configured to enable a user to re-configure the knowledge structure by:
defining the updated relationship; and
storing the updated relationship in the stickers database.

3. The method of claim 1, further comprising:
determining the set of stickers so that each sticker of the set of stickers is associated with a different sticker level, wherein the set of stickers includes one or more stickers, each of the one or more stickers corresponding to an aspect of a context related to the electronic text.

4. The method of claim 3, wherein the set of stickers further comprises a plurality of stickers configured in a hierarchy of sticker levels.

5. The method of claim 3, further comprising storing the set of stickers as a persistent property of the linked contextual element in the stickers database.

6. The method of claim 1, further comprising: initiating the action to answer a query, the query being at least a part of the contextual element.

7. The method according to claim 1, further comprising:
determining a set of stickers corresponding to a perspective of a context of the first electronic text;
storing the relationship in a stickers database representing a knowledge structure, in which the storing of the relationship modifies the knowledge structure.

8. The method of claim 7, further comprising: using input from a machine learning module to determine at least one of the following: the contextual element, the set of stickers, and the action, wherein the machine learning module is coupled with the stickers database such that the input is determined by the knowledge structure.

9. The method of claim 8, further comprising: using input from a machine learning module to determine the relationship, wherein the machine learning module is coupled with the stickers database such that the input is determined by the knowledge structure.

10. The method of claim 48, further comprising: using a further input from a user interface to modify the input from the machine learning module, wherein the user interface is coupled with the stickers database such that the knowledge structure can be further modified by the further input from the user interface.

11. The method of claim 7, further comprising: using input from a user interface to determine at least one of the following: the contextual element, the set of stickers, and the action, wherein the user interface is coupled with the stickers database such that the knowledge structure can be modified by the input.

12. The method of claim 7, further comprising: updating the relationship by using input from a machine learning module to change at least one of the contextual element and the set of stickers.

13. The method of claim 7, wherein the set of stickers comprises at least one sticker, each of the at least one sticker being associated with a respective sticker level in a hierarchy of sticker levels.

14. The method of claim 7, further comprising:
determining the action, wherein the action is determined in part by the set of stickers; and
using a result of the action to form a second electronic text;
using at least a part of the second electronic text, determining a second contextual element;
determining a second set of stickers;
linking the second contextual element with the second set of stickers to define an updated relationship related to the action; and
modifying the knowledge structure by storing the updated relationship.

15. The method of claim 6, wherein the first electronic text is an electronic message; and wherein the contextual element is determined from: at least a part of a message header of the electronic message, at least a part of a message body of the electronic message, at least a part of the message header and at least a part of the message body of the electronic message, or the electronic message as a whole.

16. A system operable by a user to manage electronic texts according to the method of claim 1, the system comprising:
a computing device coupled to the stickers database and a user interface, the computing device being configured to:
use at least a part of a first electronic text to determine a contextual element;
determine a set of stickers corresponding to the user's perspective of a context of the first electronic text; the set of stickers including at least one sticker, each of the at least one sticker being associated with a respective sticker level in a hierarchy of sticker levels, the hierarchy of sticker levels being configurable by the user through the user interface.

17. The system of claim 16, wherein the knowledge structure is configurable by the user providing input through the user interface to determine the contextual element.

18. The system of claim 16, wherein the knowledge structure is configurable by the user providing input through the user interface to determine the set of stickers.

19. The system of claim 16, wherein the knowledge structure is configurable by the user providing input through the user interface to link the contextual element with the set of stickers.

20. The system of claim 16, wherein the knowledge structure is configurable by the user providing input through the user interface to determine the action.
